(19) United States
(12) Patent Application Publication
(10) Pub. No.: US 2007/0236061 A1
(43) Pub. Date: Oct. 11, 2007

(54) Low Cost Adjustable and Foldable Car Seat

(75) Inventors: Paul K. Meeker, Hiram, OH (US); William R. Gibson, Kent, OH (US)

Correspondence Address: BUCKINGHAM, DOOLITTLE & BURROUGHS, LLP, 3800 EMBASSY PARKWAY, SUITE 300, AKRON, OH, 44333-8332, US

(73) Assignee: Meeker R&D, Inc., Hiram, OH (US)

(21) Appl. No.: 11/764,967

(22) Filed: Jun. 19, 2007

Related U.S. Application Data
(60) Provisional application No. 60/806,263, filed on Jun. 30, 2006.

(51) Int. Cl. B60N 2/26

(52) U.S. Cl. 297/250.1

(57) ABSTRACT

This invention relates generally to a juvenile belt positioning booster car seat which folds, has an adjustable back height, and has folding armrests which ships in a minimally sized carton thereby reducing shipping and warehousing costs and which has a smoother exterior surface and enclosed height adjust mechanism to prevent pinch points and protect vehicle upholstery.

### TECHNICAL FIELD

This invention relates generally to a juvenile belt positioning booster car seat (booster car seat) which folds, has an adjustable back height, and has folding armrests which ships in a minimally sized carton thereby reducing shipping and warehousing costs and which has a smoother exterior surface and enclosed height adjust mechanism to prevent pinch points and protect vehicle upholstery.

### BACKGROUND OF INVENTION

The invention relates generally to a juvenile belt positioning booster car seat (booster car seat) which folds, has an adjustable back height, and has folding armrests which ships in a minimally sized carton thereby reducing shipping and warehousing costs and which has a smoother exterior surface and enclosed height adjust mechanism to prevent pinch points and protect vehicle upholstery.

Passenger restraint systems in vehicles are generally well suited to properly restrain adults but not well suited to properly restrain children. Accordingly, vehicle restraint systems must be supplemented for maximum safety. For juveniles from approximately 30 to 80 or 100 pounds. This is accomplished with booster car seats. Booster car seats may be defined as supplementary child seats which rest on a vehicle seat and which utilize and properly position the vehicle's lap and shoulder belts to restrain a child occupant. These booster car seats include a seat portion which elevates the child above the vehicle's seating surface to a position in which the vehicle's shoulder belt is better positioned on the child and which also properly positions the vehicle's lap belt on the child's torso, and may include a back portion with a shoulder belt guide to further ensure proper shoulder belt position on the child. Booster seats typically also have accessory features such as armrests, height adjustments, energy absorbing foam, and upholstery which add to comfort, safety, convenience, or visual appeal.

A typical booster seat configuration has, as noted, a molded plastic seat with a seating surface that raises the child above the vehicle seat and a backrest with a backrest surface. These surfaces generally have adjacent side walls that help contain and protect the child occupant. Slots or recesses in the seat side walls in the occupant's hip area receive the lap belt portion of a vehicle seat belt and direct it properly over a child's pelvis (as opposed to over the soft abdominal area and internal organs). Hooks or slots on both sides of the backrest in the shoulder area receive the shoulder belt portion of the auto seatbelt and direct it properly over the child's shoulders and away from the head and neck. The booster seat thus raises the child, provides some side protection with raise side walls, and properly positions the vehicle belts on the child's smaller body. All of these functions are important and definitive. A typical booster seat configuration usually also has armrests for occupant comfort and cup holders for convenience.

Booster car seats may be constructed structurally of one piece as a rigid seat shell, as multiple pieces which are either permanently or removeably assembled, or as multiple pieces which are permanently attached and fold. Of course any accessory components such as upholstery, foam padding, armrests, or bases may be added either permanently or removeably. In all cases, structural integrity, reliability, ease and expense of manufacture, cost of distribution, and consumer appeal through comfort and ease of use are critical.

Known booster seat designs suffer from several drawbacks. L-shaped one-piece booster car seats require large and expensive shipping cartons and take up a high volume of expensive shipping space. They are said to have a high “cube”. They also require considerable space for manufacturing and retail warehousing. Further, they are difficult for consumers to store or transport when not in use, say in a vehicle trunk or in a closet, because of their high volume. Multi-piece booster car seats which are assembled by a consumer (knock-down or “KD” booster car seats) can ship in small cartons but they also have drawbacks. The very fact that the consumer must do the assembly of a safety related product is a drawback. Since consumers vary in their mechanical ability, assembly may be difficult for some and there is always the possibility that a consumer will error in the assembly. In any case, most consumers would prefer not to have to assemble a product they purchase. If the booster car seat assembles permanently, it inherits the storage disadvantage of the large L-shaped seats. But if the booster car seat assembles removeably, it has the drawback that components may be lost, that tolerances and clearances necessary for easy assembly and disassembly may result in a flimsy product, and that repeated assembly may wear the assembly means.

Folding booster car seats solve both the size problems of the one-piece seats and the problems of typical KD booster car seats. But, folding booster seats having raised sides on their seats and seatbacks must nest those sides to achieve an optimally compact fold and optimally high and protective sides-a desirable feature. Nesting with a side-to-side nest necessitates one component being wider than required and thus a higher volume product while nesting the upper faces of the seat sides and the front faces of the seatback sides leaves no space for an armrest unless it is outside of the folded seat—which again adds volume.

Known booster seats also suffer from exposed ribs and structure which are unattractive and may damage the vehicle seat upholstery. In addition, if the booster car seats have a height adjustment mechanism, it is often exposed and may have dangerous pinch points.

### SUMMARY OF INVENTION

This invention discloses a means to have a compact folding booster car seat with its inherent compact shipping size and low shipping and storage costs, deep seat and seatback sides, and a fully functional, independently rotating armrest. This invention further discloses a means to make a stronger seatback with a smoother rear surface and a fully enclosed height adjustment mechanism.

Having a folding booster car seat and one with desirable deep seat sidewalls and seatback sidewalls would seem mutually exclusive. However, booster car seats have been disclosed which fold and which nest the seat sidewalls and the back sidewalls in a side-by-side fashion (inserted nesting) and seats have been disclosed which nest the tops of seat sidewalls and the fronts of seatback sidewalls (stacked nesting). Both configurations tend to maximize both their compactness and the depth of their sidewalls.

But a folding booster car seat which utilizes inserted nesting must make either the seat side walls or the seatback side walls large enough to fit over the outside exterior of the nesting component, which again introduces excess volume or reduces the size of one component to a smaller and unacceptable width. Looking at typical vehicle bucket seats it can be observed that they have seats and backs of approximately the same width. This same configuration, with seats and backs of a similar width, is also most appropriate with booster car seats and cannot be achieved with inserted nesting.

Folding booster seats with stacked nesting allow similar seat and back widths. But the side face of the folded seat is filled with the seat sidewalls and the seatback sidewalls and there is no room left for an armrest. These problems (lack of space, need to pivot, and need to avoid pinch points) can be solved by moving the armrests outboard of the seat and back sidewalls. But moving the armrests outboard, again, increases the product volume and resulting shipping carton. It should be noted also that it is desirable for an armrest to fold for easy entry/exit from the booster car seat and for there to be some room between the folding armrest and the seat back side walls to prevent pinch points which might injure a child and thus, again, add to product width and hence volume.

Therefore, one aspect of the present invention shows a folding booster car seat with desirable deep seat and seatback sidewalls of a similar width, and desirable folding armrests sufficiently spaced from the seatback sidewalls to prevent pinching while still allowing a compact product volume and shipping carton. This invention is achieved by utilizing consumer assembled armrests mounted to rotating intermediate armrest plates.

Many booster car seats are molded single wall plastic shells with exposed rib structures on the back of their backrest surfaces or on the bottoms of their seats which interact negatively with vehicle seating surfaces by marring or damaging the vehicle upholstery. On those booster seats with adjustable headrest heights, it is common to see not only exposed ribs but also exposed adjustment mechanisms. Although some booster car seats have waffled or channeled shells with fewer exposed ribs they still generally have an unfriendly “industrial” look, exposed ribs, and exposed mechanisms. In addition to potentially marring vehicle upholstery these booster car seats have the relatively weak structure of single wall construction and the hazard of exposed mechanism susceptible to damaging the vehicle seat or causing pinch injuries.

Therefore, another aspect of the present invention is to make the rear surface of the booster seat backrest as smooth as possible by minimizing the number of exposed ribs and by enclosing the headrest height adjust mechanism, and at the same time make the shell as strong as possible in the headrest area by enclosing the height adjust mechanism within a boxlike structure formed by the exterior of the headrest and an internal headrest retention plate.

This folding, height adjustable booster car seat has two main components, a seat, and a backrest assembly which further includes a lower fixed back and an upper adjustable back. Additional components include cup holders, armrests, height adjustment mechanisms, fold latching mechanisms, headrest foam, and other minor but required components such as fasteners, springs, enclosures, upholstery, etc.

The seat has a seating surface with left and right seat sidewalls on its respective sides, left and right hollow runners under the seating surface to support the booster car seat on a vehicle seat, a back wall connecting the left and right seat sidewalls, and left and right seat hubs at the top rear of the respective seat sidewalls which are used to secure the backrest assembly, belt path recesses used to direct a vehicle lap belt, armrest plates used to mount armrests, foam blocks used to fill the hollow runners and provide a smooth seating surface, and cup holder mounts used to mount cup holders. It also includes minor features such as pad retention hooks, label recesses, engraved text, etc.

The backrest assembly includes a lower fixed back, an upper adjustable back which telescopes on the lower fixed back from a collapsed position to an extended position to accommodate various height children, a back retention panel to secure the adjustable back to the fixed back and to enclose the height adjustment mechanism, left and right adjustment latches used to facilitate adjustment of the adjustable back, a headrest foam and various facilitating parts such as screws and springs.

The fixed back includes a fixed back area with a fixed back surface with left and right raised lower sides on its left and right sides, a curved top surface, a bottom edge, and a headrest support extension with left and right position teeth on parallel side walls, and left and right backrest hubs at the lower end of the left and right raised lower sides. The fixed back area has a uniform generalized cross section across its fixed back surface and it's raised lower sides. The term “generalized” is used to indicate that the cross section ignores recesses where the backrest surface drops below where it would be if continuous. This uniform cross section sweeps on a constant arc from the bottom edge of the fixed back surface to the curved top surface. A concentric offset of the fixed back surface continues on the same constant arc on the face of the headrest support extension and for the length of the headrest support extension. This offset of the fixed back surface on the headrest support extension face will allow telescoping of a similar and concentric surface defined by a similar contour and a similar and concentric sweep. The headrest support extension is thus a narrowed, offset continuation of the fixed back surface with a width, parallel side walls, a depth, and a number of position teeth cut into its parallel side walls and it extends upward to a termination surface with a hand hole clearance cut out. The headrest support extension also has a central recessed portion with a top edge. The left and right backrest hubs have a circular outer wall and are generally hollow to their outside faces except for internal ribbing detail and two raised detents.

The adjustable back includes an adjustable backrest area with a backrest surface and left and right upper raised sides on its left and right edges, and a headrest area which will be described in more detail below. The exterior front contour of the adjustable backrest area is at all potential interference locations offset from the corresponding backrest area of the fixed back to allow for a nominal wall thickness of the adjustable back, for example 0.080 to 0.125 inch (2.03 to 3.18 mm), and some running clearance, for example 0.030 to 0.060 inch (0.076 to 1.52 mm). The adjustable back thus has a contour at least larger than the uniform generalized cross section of the fixed back swept on its constant arc and a matching offset generalized contour swept on the continuous arc and may telescope freely on the fixed back. It is intended that the front surface of the upper raised sides on the adjustable back actually extend substantially forward of the corresponding front surfaces of the fixed back. Thus the front surfaces of the left and right upper raised sides of the adjustable back are intended to project forward and result in deeper sidewalls. Ribs on their rearward surfaces can fill any consequently formed gaps between the rearward surfaces of the left and right upper raised sides of the adjustable back and the front surfaces of the respective raised lower sides of the fixed back down to the nominal running clearance. It can be seen that the adjustable back can telescope along the constant arc of the fixed back from a lower or collapsed position to a higher or extended position. It should be noted that all of the forward facing surfaces of the backrest area are smooth and that any reinforcing ribbing is located on its rearward facing surfaces. In other words, the backrest area is open to the back.

The headrest area of the adjustable back has a central surface, left and right forward projecting surfaces connected to its respective left and right edges with gently rounded corners, and a connecting bottom surface which joins all three forming a partial box. This headrest area has a nominal thickness. The forward facing surfaces of the headrest area are interrupted by various ribs and the rearward facing sides are substantially smooth. Thus the headrest area is constructed in reverse of the backrest area in that the headrest area is open to the front and the backrest area is open to the rear. The headrest area also has a left and right curved shoulder belt path that interrupts is lower edge resulting in a narrowed center region and left and right shoulder belt hooks.

The narrowed center region of the headrest area is joined to and interrupts the curved top surface of the backrest area. The connecting bottom surface of the headrest area is penetrated by an opening sized to allow passage and free up and down travel over the headrest support extension of the fixed back.

The headrest area has left and right locating ribs extending forward from its central surface and spaced apart sufficiently to allow passage and running clearance of the headrest support extension of the fixed back and projecting forward sufficiently to project above the face of the headrest support extension by a nominal running clearance. These locating ribs are topped by a back retention panel which, in conjunction with the central surface, forms a structural box which will allow free up-and-down movement of the adjustable back over the headrest support extension, and will locate the adjustable back relative to the headrest support extension both front-to-rear and side-to side.

The upper headrest area is also penetrated by a hand hole with peripheral walls somewhere near its top edge. The hand hole is so located vertically that when the adjustable back is in its lowest position the peripheral walls are concentric with the hand hole clearance in the backrest support extension and act as a stop to limit further downward travel of the upper back.

The left and right forward projecting surfaces of the headrest area are also penetrated with lock openings which locate and allow sliding movement of left and right height locks which extend through the forward projecting surfaces from inside to outside. The left and right locating ribs are interrupted in their lengths to also allow sliding movement of left and right height locks through them.

Left and right height locks are part of the backrest assembly and each slideably extends through a respective lock opening in the left and right forward projecting surface, extends inward toward the respective left and right locating ribs and terminates in locking teeth which may engage with left and right position teeth on the headrest support extension. These height locks extend beyond their respective left and right lock openings outward and terminate such that they may be pulled outward by a user. The height locks are normally spring biased inward and the locking teeth normally engage with the position teeth of the headrest support extension thus preventing upward/downward movement of the adjustable back. Pulling the height locks outward simultaneously allows free movement of the upper back, within its range of movement, by disengaging the locking teeth and position teeth. Releasing the height locks allows them to travel inward again and causes the locking teeth and the position teeth to engage in any of several possible positions of upper back travel, depending on the number and spacing of the teeth provided.

A backrest retention panel is secured to several bosses on the central portion of the headrest area, nominally with screws. The backrest retention panel is thin plastic with a nominal thickness, a left to right contour which may be flat, a vertical arc which is concentric with the constant arc of the fixed back. When it is secured it forms a boxlike structure which slideably retains the headrest support extension to the headrest area of the adjustable back and makes the central portion of the upper headrest area into a stronger double-walled structure. The rearward face of the backrest retention panel has one or more tabs or raised areas which project into the recessed portion of the headrest support extension of the fixed back. These tabs are positioned such that when the adjustable back is in its maximum desirable extension they contact the lower edge of the recessed portion and prevent further vertical movement. The backrest retention panel slideably retains the left and right height locks, slideably retains the adjustable back to the headrest support extension, and strengthens the central portion of the headrest area of the adjustable back. Additionally, the backrest retention panel provides a support surface for a headrest foam part which lines the headrest area.

The adjustable back also includes return hooks on the bottom lower edges of its left and right upper raised back outer walls. These return hooks slide over the corresponding outer walls of the lower raised sidewalls of the fixed back and slideably retain the two walls together.

After the fixed back and the adjustable back, and all of their supporting and associated components are assembled, a semi-rigid headrest foam is added to the inside of the upper headrest area to provide a smooth and comfortable headrest surface.

The seat and the backrest assembly are pivotally secured to each other on a left-to-right or common fold axis. The common fold axis on the seat is located above the seating surface and forward of the back wall of the seat and defines the axis of the seat hub. The common fold axis on the fixed back is located near the bottom edge of the fixed back and forward of the fixed back surface and defines the axis of the backrest hub. This arrangement allows the backrest assembly to pivot forward from an L-shaped position relative to the seat to a folded position more or less parallel to the seat, rotating about 105 degrees for example. The backrest assembly is selectively positioned and is retained in either position.

Fold position retention is accomplished with left and right fold latching means which ideally consists of outward biased plungers mounted in the seat hubs constrained to move toward or away from the common pivot axis in a defined channel. Each biased plunger has a plunger extension which extends through an opening in an inner wall of the respective seat hub. The plunger extensions have raised areas which normally ride inside the interior of the circular outer walls of the fixed back hubs. Thus, as the backrest assembly is moved from an L-shaped position to a folded position, the raised areas on the plunger extensions nominally travel along the insides of the circular outer walls relative to the position of the backrest assembly. However, two raised detents rise above the inside of each circular outer wall, one blocking travel out of the L-shaped position and one blocking travel out of the folded position. Each raised detent has angled leading and trailing surfaces. If sufficient rotational pressure is exerted on the backrest assembly, urging it from one position to the other, the angled leading and trailing surfaces will urge the biased plungers to move away from the insides of the circular outer walls and the raised areas of the plunger extensions will ride over the raised detents and allow the backrest assembly to move to the opposite (folded or unfolded) position. The angles of the angled leading and trailing surfaces and the amount of bias on the biased plungers can be tuned to provide the desired degree of retention in the L-shaped position and in the folded position so that the booster car seat will normally retain its folded or unfolded position but can be easily change from one to the other with modest effort and no further mechanical actuation.

In this booster car seat the attachment of the seat to the backrest assembly is accomplished by rotationally mating the inner faces of left and right seat hubs with outer faces of left and right backrest hubs. The hubs are rotationally secured with fasteners such as shoulder screws, rivets, or the like assembled into holes through the seat hubs and backrest hubs concentric with the common fold axis.

As noted the seat and the backrest assembly each have raised sides adjacent to their seating surfaces. The seating surface and the backrest surface are about the same width and their respective raised sides are about the same width. The top surfaces of the seat sidewalls nest with the front surfaces of the backrest assembly with generally convex front-to-back curves on the front surfaces of the seat component nesting with generally concave overall form of the front surfaces of the seatback assembly when it is in its lowest position. Thus when the booster car seat is folded the collective raised sides substantially fill the sidewall area between the seating surface and the backrest surface except for nominal clearance for upholstery and spaces generated by gently rounded corners: there is no room for armrests and they must be attached to the exterior of the booster car seat where they cause an increase in carton size.

Left and right armrests are attached to the exterior of the booster car seat on the outside of the collective raised sides. Although it would be ideal to have the armrests be the same width as the collective raised sides, that, again, is prevented because the collective raised sides essentially fill the space an armrest would occupy when the booster car seat is folded. In order to allow easy entry and exit from the booster car seat, the armrests fold on a common armrest axis which is ideally, but not necessarily, also the common fold axis. The armrest fold is independent of the booster car seat fold and it is limited to a given degree of rotation, rotating about 85° for example.

Since the armrests are forced to be mounted to the exterior of the booster car seat they would normally force the shipping carton to be wider. This problem is solved by making the armrests consumer assembled. Thus, the booster car seat may be shipped in a smaller carton with the armrests loose in the carton and the consumer installs them. The armrests must thus be rotationally attached, limited in their travel, sturdy, easy to attach by people with limited mechanical skills and not generate pinch points.

This set of complex armrest constraints is solved by mounting the armrests to intermediate left and right armrest plates which rotationally attach to the outer faces of the seat hubs ideally with the same fasteners which secure the seat and backrest assembly together. The armrest plates are limited to a specified rotation by means of rotation limiting projections on their inner faces which are stopped by the plunger guide ribs in the seat hubs. The outer faces of the armrest plates are provided with T-shaped protrusions to which the armrests slideably attach by means of C-shaped recesses on their inner faces. This armrest attachment means is made a one-time assembly by means of flexible finger on each armrest plate which rides over the top edge of each armrest C-shaped recess and then snaps into a locking position behind the top edge. Each armrest is spaced apart from its neighboring raised sidewall sufficiently to prevent pinch points. Although the invention describes mounting the armrests on the same axis as the fold, the invention is intended to encompass any mounting location on any car seat, folding or non-folding.

Although the armrests describe are preferably attached with mating T-shaped keys and C-shaped keyways, many alternative attachments are possible. For example, the T-shaped keys may be any linear or circular protrusion on either the intermediate plates or armrests described mating with any corresponding linear or circular receiver on the respective mating component. As another example, the armrest may be simply attached with screws to the intermediate plates.

In addition, though the armrest mounting using intermediate plates and keyway attachment has been described on a folding booster seat with an extendable back, the armrests could also be applied to a non-folding booster seat or one without an extendable back.

In one aspect of the present invention, the consumer installed pivoting armrests allows a smaller more economical shipping carton, lower warehousing, and lower shipping costs.

In another aspect of the invention, smooth exterior walls on the headrest and enclosed height adjustment mechanisms help prevent damage to vehicle upholstery and pinch injuries.

These and other objects of the present invention will become more readily apparent from a reading of the following detailed description taken in conjunction with the accompanying drawings, wherein like reference numerals indicate similar parts, and with further reference to the appended claims.

### BRIEF DESCRIPTION OF DRAWINGS

FIG. 1 is a front perspective a foldable booster car seat with an extendible backrest in its L-shaped position and showing the moveable portion of the backrest in a fully collapsed position, armrests in their usage position, and cup holders in their storage position;

FIG. 2 is a side view of the booster car seat of FIG. 1 showing the backrest in its folded or collapsed position illustrating nesting curvilinear alignment;

FIG. 3 is a top view of FIG. 2 showing one armrest removed and a phantom line of a shipping carton illustrating the need to remove the armrests of the car seat in order to fit within a standard sized shipping carton without incurring overage fees, particularly those based on courier service shipping limitations, namely girth plus length restrictions of 84 inches (213 cm);

FIG. 4 is a perspective view of FIG. 2;

FIG. 5 is a view similar to FIG. 4 showing one armrest removed exposing the exterior of the armrest handle hub;

FIG. 6A is a partial close-up view of FIG. 5 showing details used for C-shaped keyway armrest attachment;

FIG. 6B is a partial close-up view showing details for an alternative embodiment for the attachment of the armrest to the plate of the car seat;

FIG. 7A is an inside perspective view of the right armrest showing attachment detail for FIG. 6A;

FIG. 7B is an inside perspective view of the right armrest showing attachment detail for FIG. 6B;

FIG. 8 is a side perspective view of the armrest hub of FIG. 6A with the armrest attachment plate removed;

FIG. 9 is a side perspective view of FIG. 8 with the seat and associated seat hub removed;

FIG. 10 is a front perspective view of the booster car seat of FIG. 1 showing the extendible backrest in its extended position, armrests in their raised position, and cup holders in their use position;

FIG. 11 is an enlarged perspective view of FIG. 10 with the headrest foam removed showing the back retention panel;

FIG. 12 is a perspective view of FIG. 11 with the back retention panel removed to show the height adjustment mechanism;

FIG. 13 is a rear perspective view of the back retention panel;

FIG. 14 is a view similar to FIG. 12 showing the moveable portion of the backrest in its fully collapsed position;

FIG. 15 is an exploded assembly view of the booster car seat shown in FIG. 1;

FIG. 16 is a partial exploded close-up view of FIG. 15 showing left armrest details viewed from an outside point-of-view;

FIG. 17 is a partial exploded close-up view of FIG. 15 showing right armrest details viewed from an inside point-of-view;

FIG. 18 is a partial close-up view of FIG. 14 showing the adjustable back locking detail;

FIG. 19 is a perspective view of a non-folding, non-extendable back version of the car seat of FIG. 1;

FIG. 20 is an enlarged perspective view of the keyed intermediate plate arrangement; and

FIG. 21 is an alternative armrest hub configuration to mate with the keys of FIG. 20.

### DETAILED DESCRIPTION OF THE INVENTION

Referring now to the drawings wherein the showings are for purposes of illustrating the preferred embodiment of the invention only and not for purposes of limiting the same, the figures show a foldable booster car seat with consumer assembled armrests which will ship in a reduced space and an adjustable backrest to better accommodate occupants of different heights and weights and with a smooth back surface with enclosed adjusting mechanism.

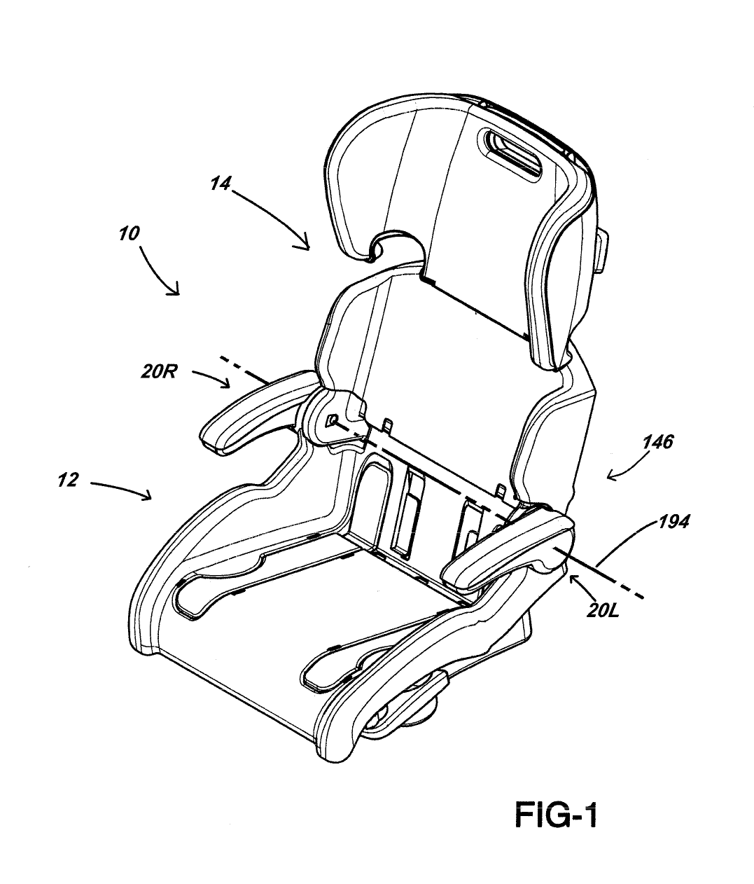

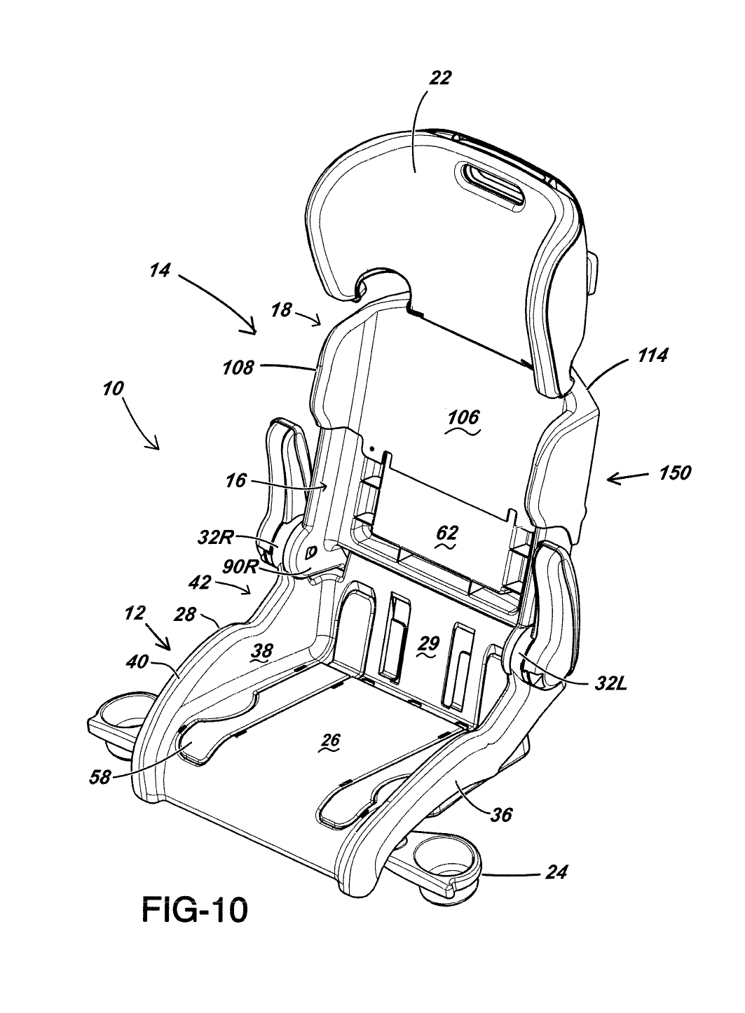

As most easily seen in FIGS. 1 and 10, booster car seat 10 has two main components, seat component 12 and backrest assembly 14 which is further subdivided into fixed back 16 and adjustable (i.e., movable) back 18. Additional easily seen components are left and right armrests 20L and 20R, headrest foam 22, and cup holders 24.

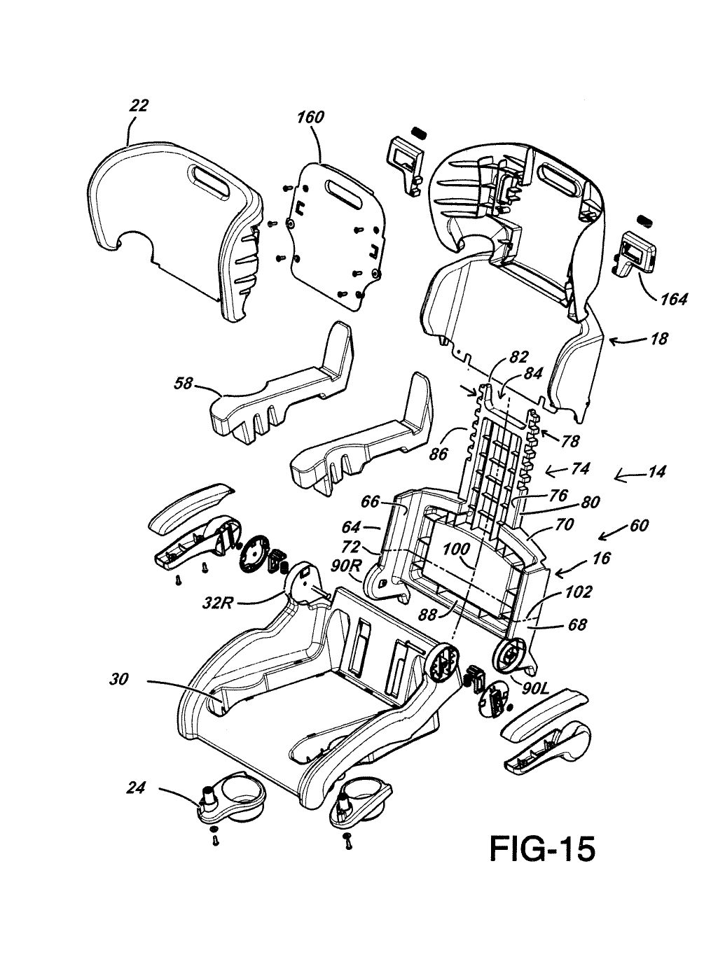

Seat 12 has a seating surface 26 with left and right seat sidewalls 28 on its respective sides, left and right hollow runners 30 (best seen in FIG. 15) under the seating surface 26 to support the booster car seat 10 on a vehicle seat (not shown). Seat component 12 further includes back wall 29 which connects left and right sidewalls 28. Left and right seat hubs 32L and 32R respectively, at the top rear of sidewalls 28 are used to secure backrest assembly 14. Belt path recesses or indentations 42 are used to direct a vehicle lap belt (not shown) across the bony pelvis of an occupant of the car seat. Seat 12 is fitted with foam blocks 58 to fill hollow runners 30 and make seating surface 26 continuous left to right across the car seat.

Left and right seat sidewalls 28 have outside walls 36, inside walls 38, and top surface 40 and these raised curvilinear profiles are generally hollow and open to the bottom. Belt path recesses or indentations 42 form a part of top surface 40 and are located generally below armrest hubs 32L and 32R.

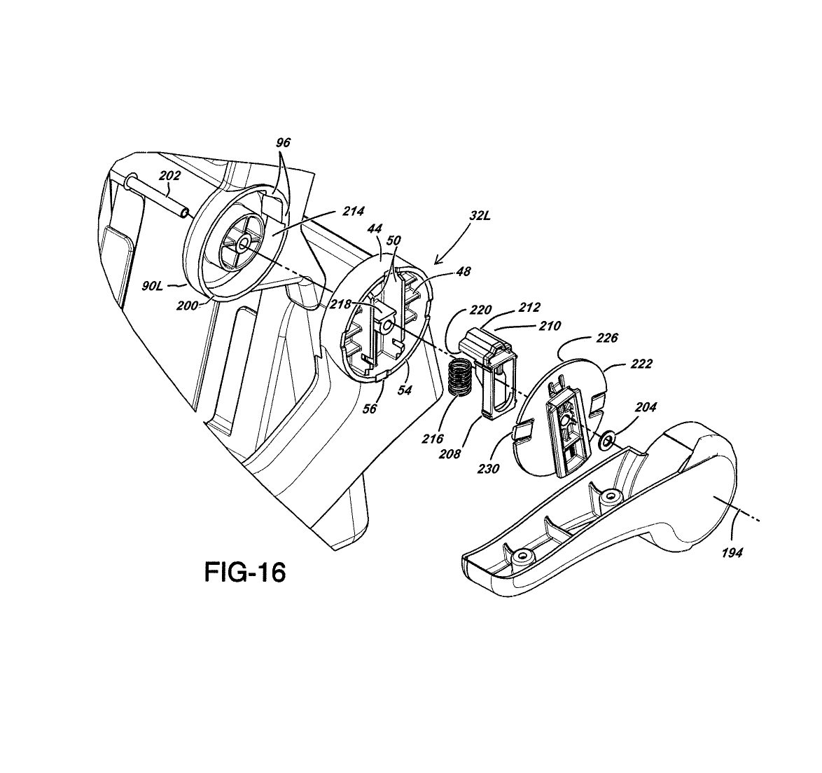

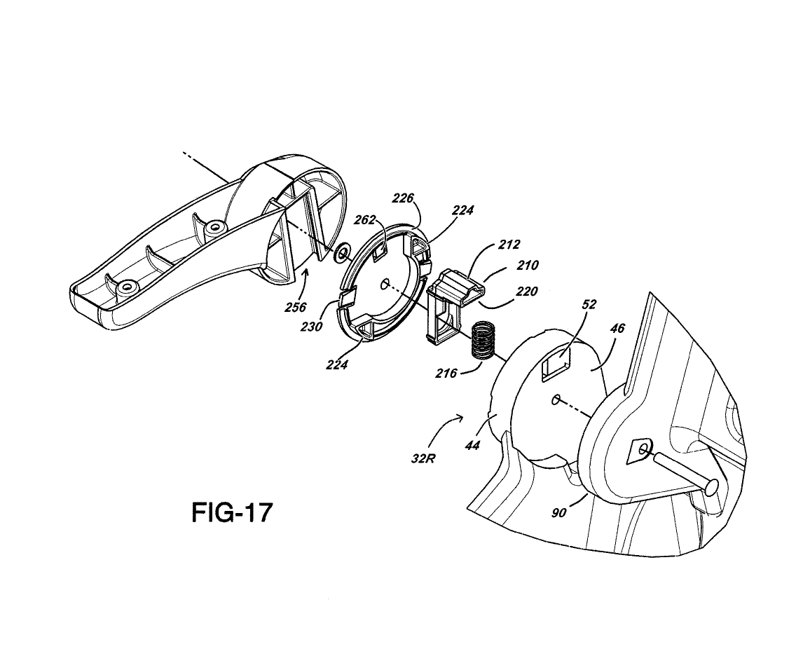

As most easily seen in FIGS. 16 and 17, seat hubs 32L and 32R have outer circular walls 44 and inner faces 46 and are hollow to the outside except for reinforcing ribs 48. Reinforcing ribs include plunger guide ribs or rails 50. Openings 52 (illustrated in FIG. 17) penetrate inner faces 46 between plunger guide ribs 50. Seat hubs terminate in outside face or peripheral edge 54 which are interrupted by recessed detent notches 56.

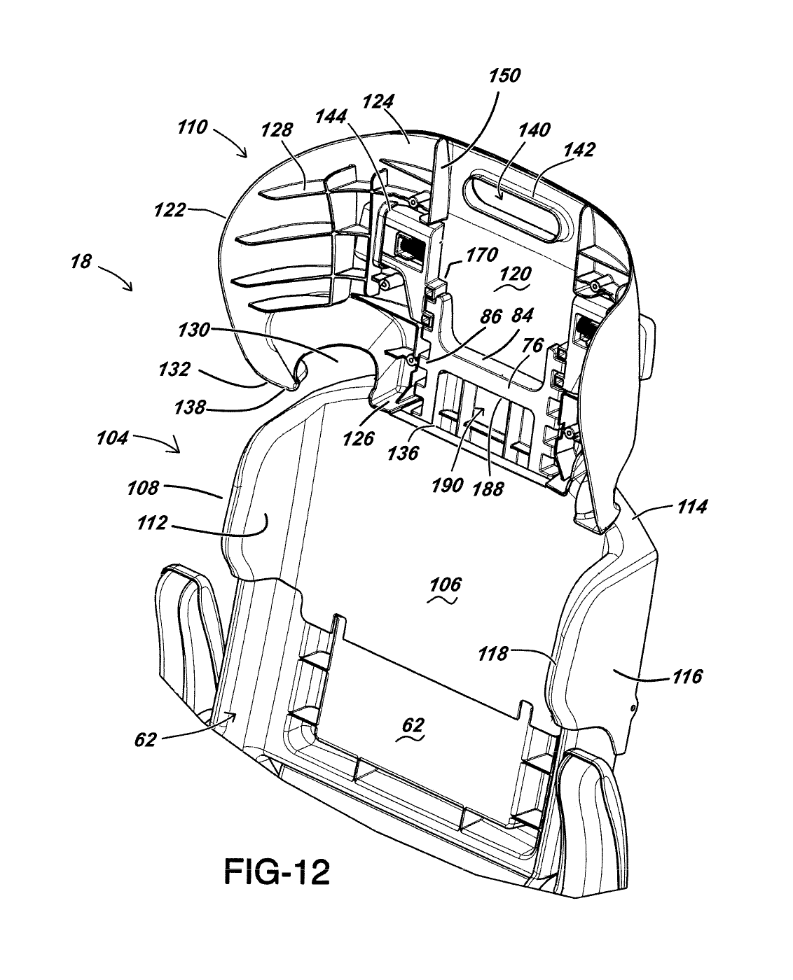

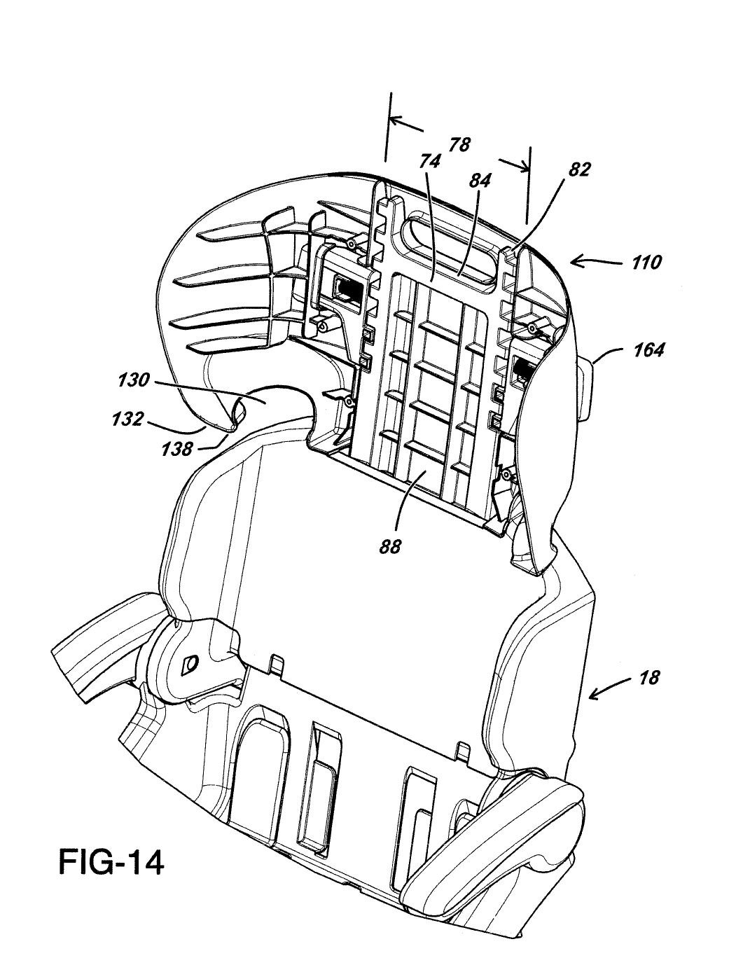

Referring now to FIGS. 10 and 15, fixed back 16 has a fixed back area 60 which includes a fixed back surface 62 and left and right raised lower sides 64 on its respective edges and curved top surface 70. Raised lower sides 64, in turn, have inside walls 66, outside walls 68 and front surfaces or edges 72. Fixed back 16 also has headrest support extension 74 which has a front face 76 which is concentric with fixed back surface 62, width 78 (better illustrated in FIG. 14), parallel left and right side walls 80, a termination surface 82 and a hand hole clearance 84. A plurality (and at least three) of left and right height adjustment teeth 86 are formed into side walls 80. Fixed back has a recessed portion 190 (see FIG. 12) with a top edge 188.

As best seen in FIGS. 9 or 15, fixed back 16 also has left and right backrest hubs 90L and 90R located near the bottom of raised lower sides 64 and forward of back surface 62. These hubs have circular outer walls 92 and are hollow to the outside except for internal ribbing 94. They additionally have raised detents 96 protruding interiorly from the internal periphery with outer faces or peripheral edge 200. Fixed back also has left and right stand legs 98 such that folded booster car seat 10 will stand on end when in the collapsed position.

Referring now again to FIG. 15, fixed back area 60 has a longitudinal contour defined as a constant arc 100 and shown as a phantom line and a lateral contour 102 also shown as a phantom line. Lateral contour 102 ignores any recesses 88 and may thus be considered “generalized”. Back area 60 is defined by the generalized contour of sweeping lateral contour 102 on constant arc 100.

Referring to FIG. 12, adjustable back 18 has an adjustable backrest area 104 and a headrest area 110. Backrest area 104 has a backrest surface 106 and raised curvilinear sides 108 and top curved surface 114. Raised sides 108 have inner walls 112, outer walls 116, and left and right front surfaces 118. Backrest area 104 is open to the back and is a contiguous, smooth surface on its front. Headrest area 110 has central surface 120, left and right forward projecting surfaces 122 connected with gently rounded corners 124, and connecting bottom surface 126 forming a partial box-like structure open to the front. Headrest area 110 has a nominal generally uniform thickness. The forward facing surfaces of the headrest area 110 are interrupted by various ribs 128 and the back surfaces are substantially smooth. Headrest area 110 is constructed in reverse of the backrest area 104 in that the backrest area 104 is open to the back and can provide a smooth seating area while the headrest area is open to the front and cannot provide a smooth area absent the application of foam insert 22.

Headrest area 110 has a left and right curved shoulder belt path opening 130 that interrupts its lower edge 132 resulting in a narrowed center region and left and right shoulder belt hooks 138. This narrowed center region is joined to and interrupts top curved surface 114. The connecting bottom surface 126 is penetrated by an opening 136 sized to allow passage and free up-and-down movement of headrest support extension 74 of fixed back 16.

Adjustable back 18 is assembled to the fixed back with backrest surface 106 in front of and concentric with fixed back surface 62 and opening 136 is penetrated by headrest support extension 74. Adjustable back 18 may travel between a lowest position 146 and a highest position 150 shown in FIGS. 1 and 10 respectively.

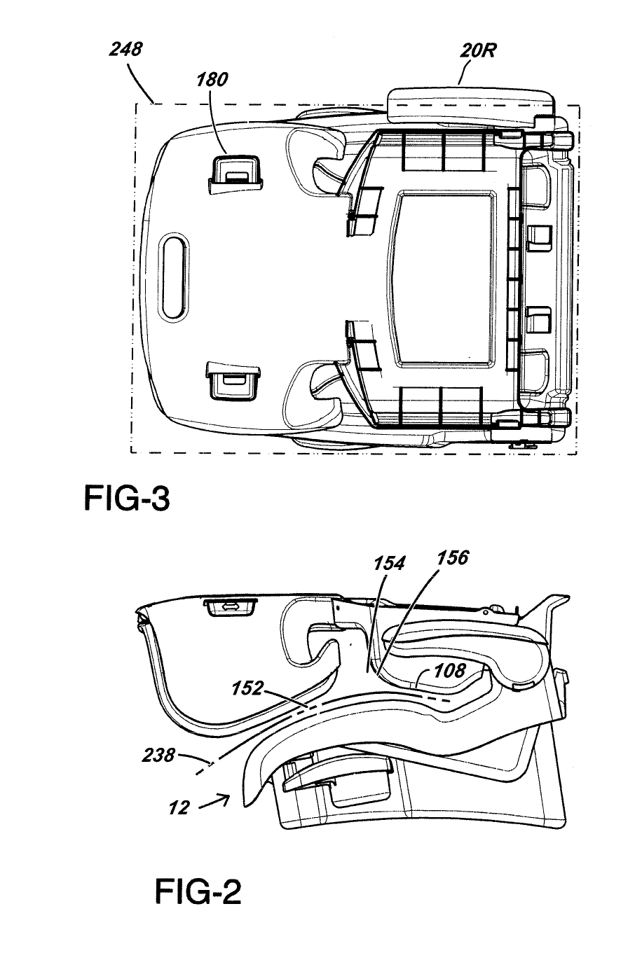

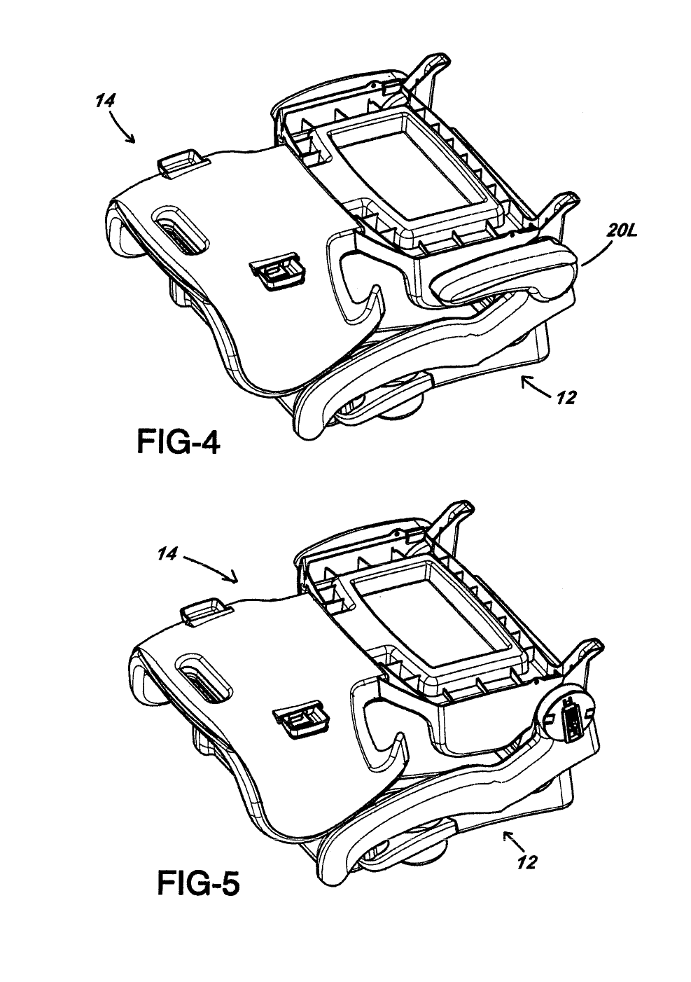

Referring again to FIG. 12, all areas of adjustable back area 106 are, at all potential interference locations, offset from corresponding areas of fixed back area 62 by a nominal wall thickness, for example 0.080 to 0.125 inch (2.03 to 3.18 mm), plus a nominal running clearance, for example 0.030 to 0.060 inches (0.076 to 1.52 mm). Adjustable back 18 may therefore rotationally telescope on fixed back 16. It is intended that front surfaces 118 of upper raised sides 108 of the adjustable back area 104 actually extend further forward from corresponding top surfaces 72 of raised lower sides 64 resulting in taller upper raised sides 108 than would be required. It is also intended, as shown in FIG. 2, that top curved surface 118 is expanded to generally fill space available except for nominal upholstery clearance 152 and spaces 154 caused by gently rounded corners 156 when booster car seat 10 is folded.

Still referring to FIG. 12, when adjustable back 18 is in any possible adjustment position, all areas of central surface 120 of headrest area 110 lie behind headrest support extension 74 and are separated from it by some nominal running clearance. Thus when adjustable back 18 is assembled to fixed back 16, backrest area 106 of adjustable back 18 is in front of fixed back area 62 of fixed back 16 and headrest area 110 central surface 120 is behind headrest support extension 74. This arrangement of components allows the smooth side of the headrest area 110 to lie on a vehicle seat back when the booster car seat is installed in a vehicle.

Headrest area 110 is also penetrated by hand hole opening 140 and left and right lock openings 144 (see also FIG. 18). Hand hole opening 140 penetrates central surface 120 and is surrounded by peripheral wall 142 and is located so that when adjustable back 18 is in it lowest position 146 it is concentric with hand hole clearance 84 in headrest support extension 74 and peripheral wall 142 may act as a stop to prevent adjustable back 18 from moving lower (see FIG. 14). Left and right lock openings 144 penetrate respective forward projecting surfaces 122 or gently rounded corners 124 and slideably locate left and right height locks 164.

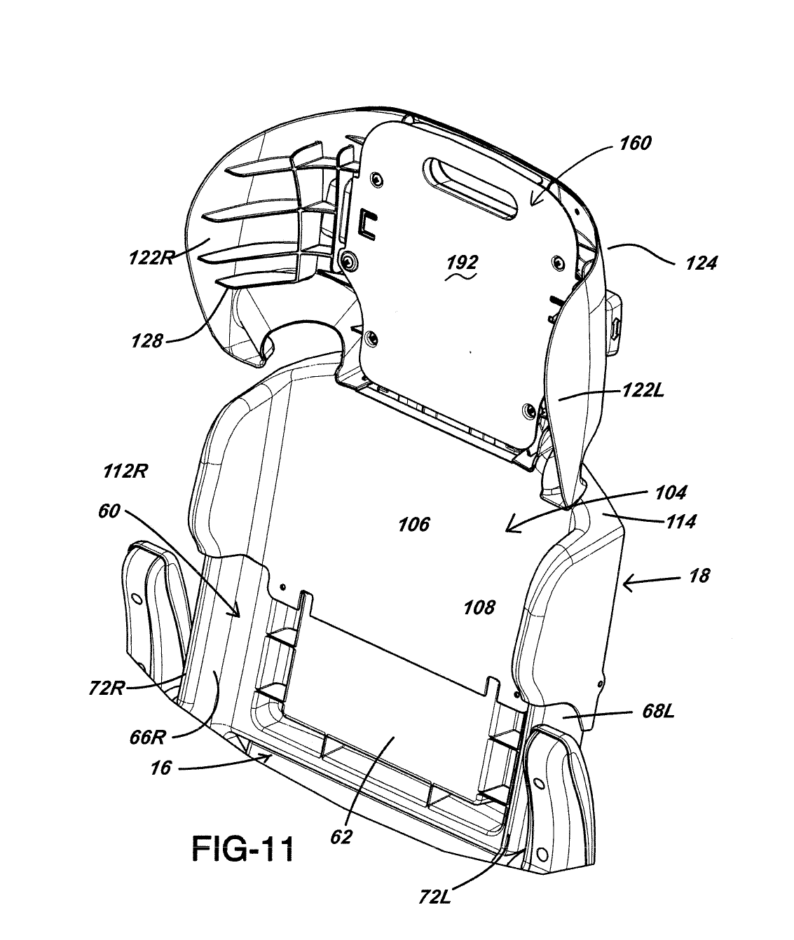

As shown in FIG. 12, headrest area 110 also has left and right locating ribs 150 extending forward from its central surface 120 and spaced apart sufficiently to allow passage and running clearance of headrest support extension 74 and projecting forward sufficiently to project above face 76 of headrest support extension 74 by a nominal running clearance. These locating ribs 150 are topped by a secured back retention panel 160 (see FIG. 11) which in conjunction with central surface 120 forms a structural box which will allow free up-and-down movement of adjustable back 18 over the headrest support extension 74 and will locate headrest extension 74 side to side and front to back.

Referring to the close-up view FIG. 18, left and right height locks 164 slideably assemble into respective lock openings 144. Height locks have a lock body 166, a guide opening 168, and a number of lock teeth 170. Lock springs 176 bias height locks inward by pushing on end 172 of guide opening 168 and on spring post 174 mounted to central surface 120 of headrest area 110. Height locks 164 are guided by left and right slide ribs 178 on central surface 120. Locating ribs 158 are interrupted to allow lock teeth 170 to engage height adjustment teeth 86 on fixed back extension 74. Normally spring bias urges lock teeth 170 into height adjustment teeth 86 thereby fixing the position of adjustable back 18. Ends 180 of height locks 164 extend outward beyond the outer surface of headrest area 110 (see FIG. 3) and are formed so they may be grasped and pulled. Simultaneously pulling height locks 164 urges compression of lock springs 176 and disengages lock teeth 170 from height adjustment teeth 86 allowing telescoping movement of adjustable back 18. Releasing height locks again allows springs 176 to urge lock teeth 170 to engage adjustment teeth 86 with adjustable back 18 in any of several height positions determined by the number and spacing of corresponding teeth. Height locks are further slideably located by back retention panel 160.

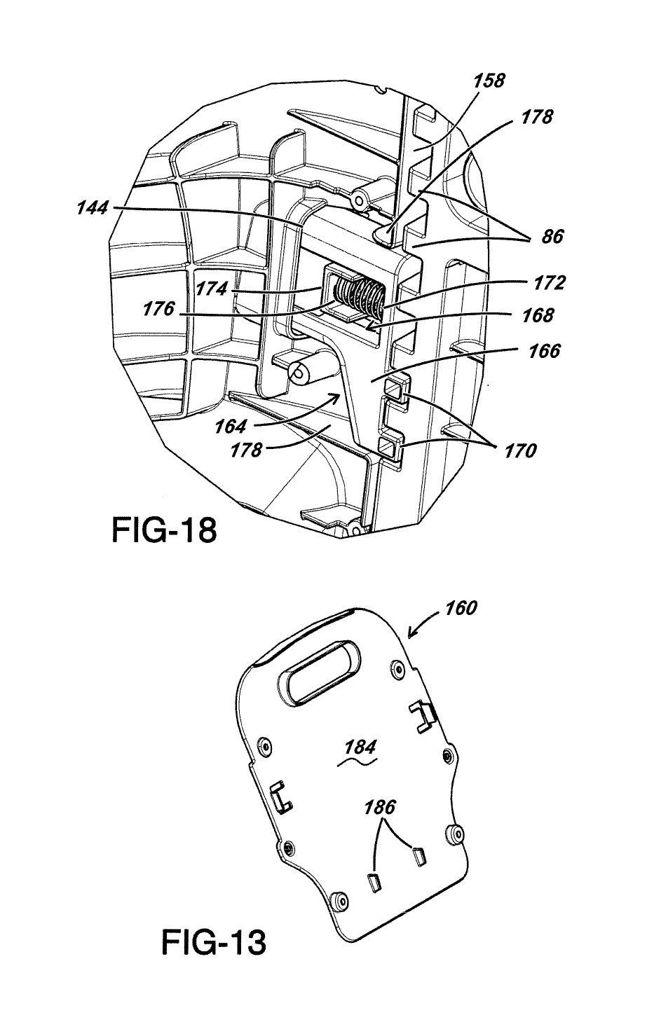

Referring now to FIGS. 11 and 13, backrest retention panel 160 is secured to adjustable back 18 preferably with screws and strengthens central surface 120 by making a double wall boxlike structure and, in addition, slideably locates headrest support extension 74 and height locks 164. Rear surface 184 of backrest retention panel has raised protrusions 186 which are so located that when adjustable back 18 is in its highest position 150 raised protrusions 186 contact top edge 188 of recessed portion 190 of headrest support extension 74 (see FIG. 12) preventing further upward movement and thus securing adjustable back 18 to fixed back 16. Further, front surface 192 of backrest retention panel 160 serves as a mounting surface for headrest foam 22.

As can be seen in FIG. 10, headrest foam 22 mounts to front surface 192 of backrest retention panel 160 and provides a smooth and energy absorbing lining to headrest area 110 and is secured with hot-melt adhesive, friction, or other convenient method.

Referring to FIGS. 1 and 16, in a preferred embodiment, seat hubs 32 share fold axis 194 with backrest hubs 90. Seat 12 and backrest assembly 14 pivotally assemble on fold axis 194 with seat hub 32 inner faces 46 pivotally mating with outer surfaces 200 of backrest hubs 90 as shown in FIG. 17. Backrest assembly may pivot on fold axis 194 from a generally L-shaped usage position as shown in FIG. 1 to a compact folded position as shown in FIG. 2.

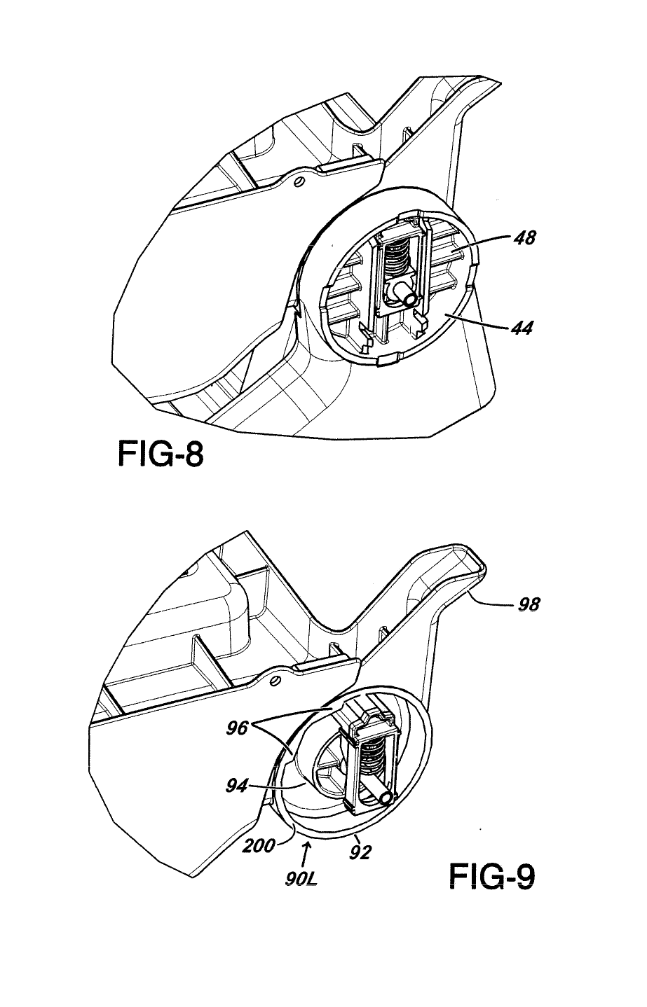

As may be best seen in exploded FIG. 16 but may also be visualized by referring to FIGS. 8, 9 and 17, backrest assembly 14 is retained in L-shaped position or compact folded position by a fold latching means which preferably comprises outward biased plungers 208 which slideably assemble between plunger guide ribs or rails 50 in respective seat hubs 32 such that they may move toward or away from common fold axis 194. Each plunger 208 has a plunger extension 210 which projects through respective openings 52 (see FIG. 17) in inner faces 46 of seat hubs 32. Plungers 208 are biased outward preferably by springs 216 acting on hub spring surfaces 218 and underside 220 of plunger extension 210. Each plunger extension 210 has at least one raised area 212 which rides on inner wall 214 of backrest hubs 90. Raised detents 96 protrude from inner wall 214 between the position raised area 212 on plunger extensions 210 occupies when backrest assembly 14 is in its L-shaped position, and the position raised area 212 on plunger extensions 210 occupies when backrest assembly 14 is in its folded position. Backrest assembly 14 is thus prevented from moving from either L-shaped position or compact folded position by rotational movement being blocked by raised detents 96. However, exerting sufficient rotational force on backrest assembly to move it from either position will cause raised areas 212 to overcome spring bias and override raised detents 96. The amount of force required to move backrest assembly 14 from one position to the other can be controlled by the strength of springs 216 coupled with the shape of raised detents 96 and raised areas 212. The nominal amount of force required is great enough to prevent gravity from changing the position of the backrest assembly yet light enough to allow easy change by a consumer.

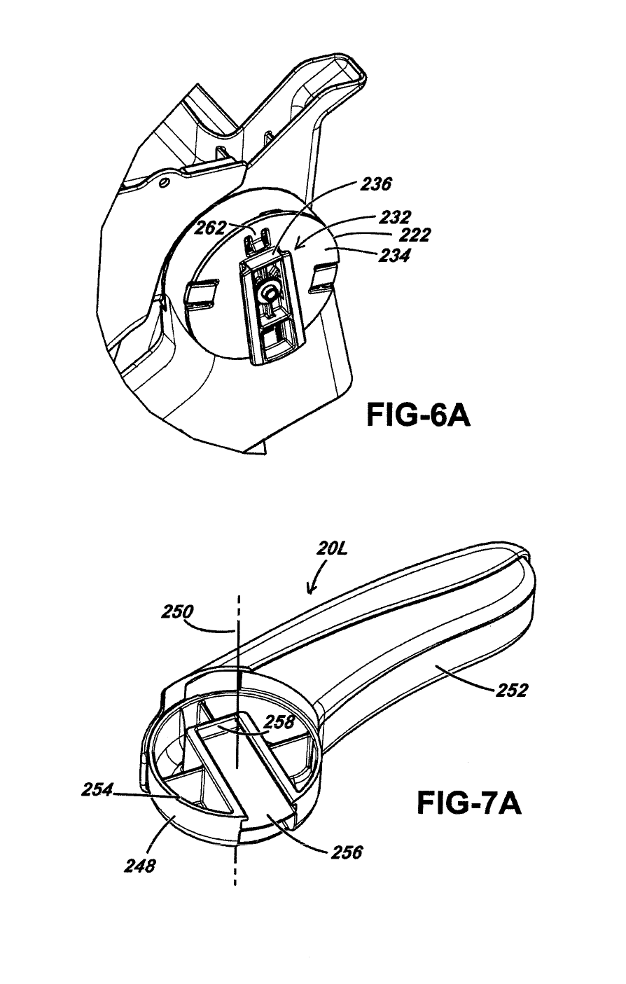

Referring now primarily to FIG. 16, but also with reference to FIGS. 6A and 17, armrest plates 222 pivotally mount to seat hubs 32 with rivet 202 and washer 204 and with plate inside faces 226 mating with respective seat hub 32 outside faces 54 and rotate independently of backrest assembly 14 on common fold axis 194. Armrest plates retain plungers 208 in seat hubs 32. Armrest plates have raised projections 224 on plate inside faces 226 (see FIG. 17). Raised projections intrude into respective hollow seat hubs 32 between guide ribs 50 and outer circular walls 44 and allow armrest plates 222 to rotate clockwise or counterclockwise until raised projections 224 contact plunger guide ribs 50. This allowed rotation ranges from 60-120°, more preferably from 80-90°, and most preferably for example, 85°. Seat hubs 32 have sets of indented areas 56 and armrest plates 222 have sets of spring fingers 230 projecting upward from plate inside faces 226. When armrest plates 222 are rotated clockwise to their limit of travel spring fingers 230 engage appropriately placed indented areas 56 and urge armrest plates 222 to remain in that position. When armrest plates 222 are rotated counterclockwise to their limit of travel spring fingers 230 engage appropriately placed indented areas 56 and, again, urge armrest plates to remain in that position. By applying sufficient rotational force to armrest plates 222, spring fingers 230 can be forced out of indented areas 56 allowing armrest plates to rotate. The amount of force required to rotate armrest plates 222 out of detented position can be controlled by varying the strength, shape, and projection of spring fingers 230 and by varying the shape and depth of indented areas 56. Armrest plates 222 have raised T-shaped protrusions 232 (see FIG. 6A) on their respective outside faces 234 which form flanged keys and which extend approximately % of the way across outside faces 234 and terminate in top edges 236. Raised snap fingers 262 raise above outer faces 234 some nominal distance, and about ⅛ inch (3.18 mm) from top edges 236 of T-shaped protrusions 232 thereby making the attachment of the armrest unidirectional.

As noted, seat 12 and backrest assembly 14 components fixed back 16 and adjustable back 18 have raised sides adjacent to their seating surfaces and these raised sides are about the same width. As can be seen in FIG. 2 showing booster car seat 10 in compact folded position, the forward most extremes of backrest assembly 14 and headrest foam 22 have a generally concave form illustrated by phantom nest curve 238. Nesting sidewalls essentially fill all space available for nesting except for nominal clearance for upholstery 152, and corner rounding space 154 generated by gently rounded corners 156.

Armrests are a desirable feature to have on a booster car seat and ideally armrests would be installed at the same general width as raised seat sidewalls 28 of seat 12. But as just illustrated in this booster car seat 10 that space is fully used when backrest assembly 14 is in compact folded position. Therefore, any armrests must be moved outboard of upper raised sides 108 of adjustable back 18. It is also a desirable feature to have armrests fold for easy user access and exit from a seat. Again, any armrests must be mounted outboard of upper raised sides 108 to allow a sufficient fold for easy access and exit, but any armrests should be mounted even further outboard to prevent pinch points between any armrests and upper raised sides 108.

Now, looking at FIG. 3, a right armrest 20R is shown mounted as described above and a carton size 248 is shown in phantom line. If armrests are mounted the carton size increases and carton cost and shipping and warehousing costs will increase. This problem is solved by making left and right armrests 20L and 20R consumer assembled.

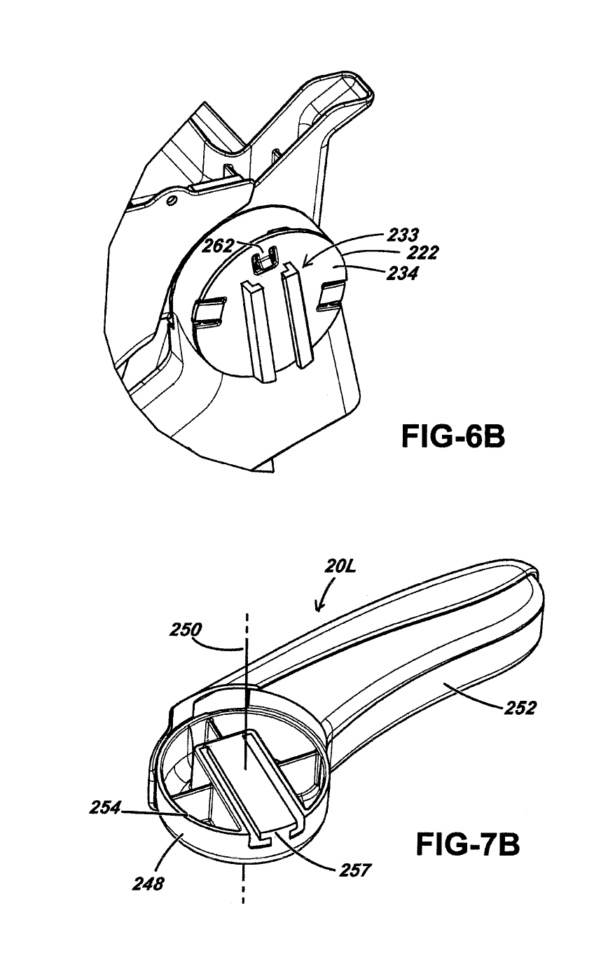

As shown in FIGS. 6A and 7A, left and right armrests 20L and 20R have respective circular armrest hubs 248 with armrest axis 250 and inner faces 254 and they also have arms 252. Armrest hubs have recessed C-shaped keyways 256 set into inner faces 254 and open to the bottom. Keyways terminate in walls 258. Armrests are assembled by engaging respective C-shaped keyways 256 over T-shaped protrusions 232 on armrest plates 222 and pushing armrests 20 until armrest axis 250 aligns with common fold axis 194. As armrests slide into position raised snap fingers 262 (see FIG. 6A) in armrest plates 222 ride over walls 258 and snap behind walls 258 locking armrests 20 in place. As illustrated in FIGS. 6B and 7B, it is illustrated that the keys and keyways of FIGS. 6A and 7A may be reversed, where armrest plates 222 have C-shaped keyways 233 and armrests 20 have T-shaped protrusions 257. It can also be easily visualized that any interlocking or male/female attachment means can replace the key / keyway attachment means illustrated.

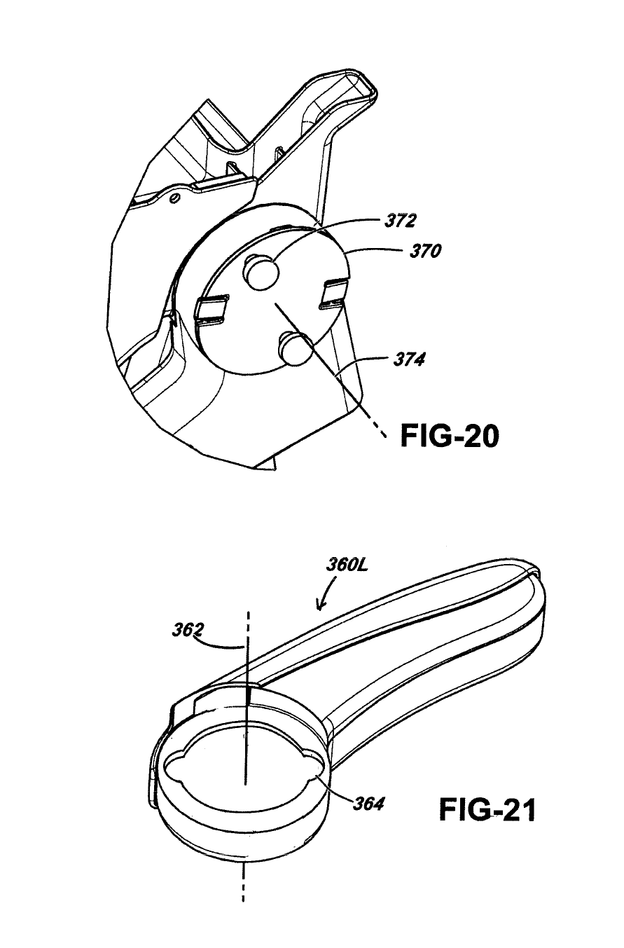

The preferred armrest attachment has been described. However, alternative attachment means may be employed. For example, looking at FIGS. 20 and 21 it can be seen that a rotational set of protrusions would be equally effective. In FIG. 20, standing keys 372 on alternative intermediate plate 370 with axis 374 mates with alternative armrest 360L, circular cutouts 364, and rotates on armrest axis 362 (which aligns with axis 374) to secure armrest 360L to intermediate plate 370. Another alternative would be to simply screw armrest 360 to intermediate plate 370.

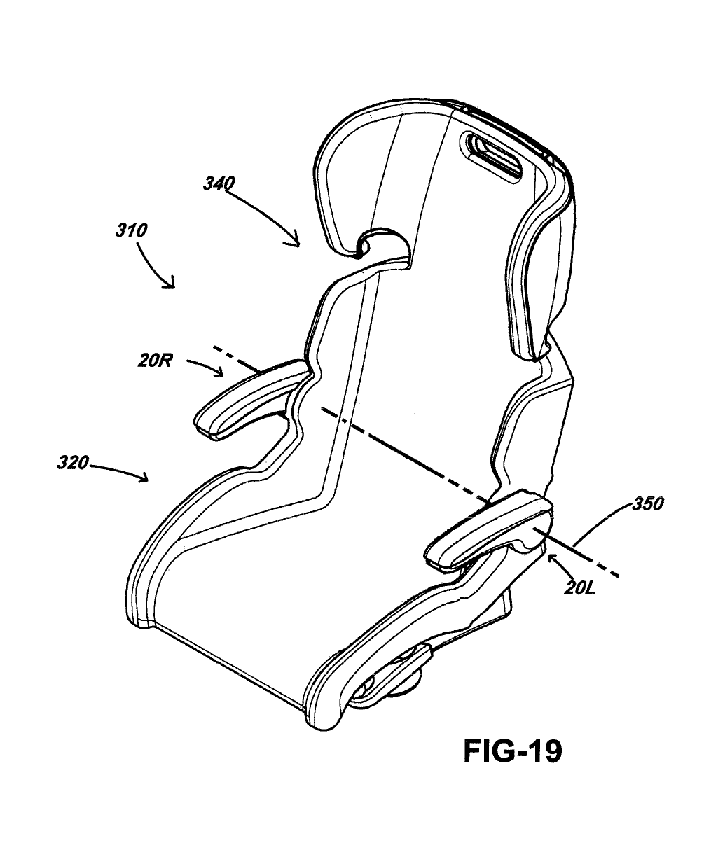

As illustrated in FIG. 19, it can be seen that the armrests 20L and 20R described can be assembled to alternative booster car seat 310 with seat area 320 and back area 340 in a continuous, non-folding and non-extending arrangement. The armrests 20 still mount to intermediate plates outboard of back area 340, still pivot on axis 350, and still provide many of the space saving packaging and rotational benefits described in the preferred embodiment.

Therefore, what has been shown is a car seat and subassembly components. In one embodiment, the foldable car seat will have an extendable back with raised curvilinear sides, a seat portion having nesting raised curvilinear sides pivotally connected to the back, the seat width and the car seat back being essentially the same with a pair of oppositely attached rotatable armrests. The car seat preferably has a pair of hubs at the bottom of the extendable back, a pair of hubs at the rear of the seat, and a pair of hubs at the rear of the armrests. In a most preferred combination, the hubs will be a combination hub of the three identified individual hubs, the combination hub further containing a means for retaining the armrest in either its up or down position as well as a means for retaining the extendable back and seating surface in either its L-shaped or collapsed position. The armrests are unidirectionally attached to the hub combination by a user installer after purchase of the product and removal from its container or carton.

The extendable back will have a lower fixed back portion, and an upper adjustable back portion which telescopes in relation to the fixed back portion, the upper adjustable back portion moving from at least one first collapsed position to at least one second extended position. The extendable back will additionally have a height adjustment means to secure the upper adjustable back portion into either at least a first or a second position.

The foldable car seat will typically have a lowered area in the sides of the seating portion of the seat for securing an automobile lap belt to fit onto an occupant's bony pelvis.

In a more generalized teaching, the foldable car seat will have a back with raised curvilinear sides, a seat portion with nesting raised curvilinear sides pivotally connected to the back, with the widths of the seat portion and the back portion being about the same. A pair of rotatable armrests are unidirectionally attached to the seat by a user installer after purchase of the product, the armrests separated by a distance across the car seat which is greater than the width dimension across the back. The car seat has a connection means for the seat and back, this connection means further having a means for retaining the back and seat in either an L-shaped or collapsed position as well as a connection means for the unidirectionally attached armrests, this connection means further having a means for retaining the armrests in either an up or a down position.

In a preferred embodiment, the car seat connection means for the seat and back as well as the connection means for the armrests are on a common fold axis located above the seating surface of the seat and forward of the back wall of the back.

A method is also taught in this invention for reducing the cube size of a car seat for shipping purposes when the car seat has approximately equal widths between a pair of raised curvilinear sides of the seating surface of the car seat and between a pair of raised curvilinear sides of the back of the car seat, particularly when the car seat is equipped to have a pair of rotatable armrests separated by a distance which is greater than the width between the curvilinear sides of the back. As used in the shipping industry, cube size is a combination of packaging carton length times width times height. The method employs the steps of folding said car seat along a fold axis, the axis located above the seating surface of the seat and forward of the back wall of the back, prior to insertion of said car seat into said packaging carton, with insertion of a pair of armrests into the carton. After receipt of the carton at the destination and removal of the folded seat and armrests, they are unidirectionally installed onto the car seat with a connection means which provides the installer with feedback.

The unidirectional armrest installation step includes matingly engaging a T-shaped protrusion on the exterior surface of an armrest plate in a hub on the car seat, with a C-shaped channel in the interior side of the armrest. The armrest plate additionally has at least one exteriorly-facing snap finger positioned interior of a peripheral edge of the armrest plate which upon proper and complete installation will provide sensory feedback to the installer. This feedback may be visual, audio (sound) or tactile (decreased resistance).

This invention has been described in detail with reference to specific embodiments thereof, including the respective best modes for carrying out each embodiment. It shall be understood that these illustrations are by way of example and not by way of limitation. Accordingly, the scope and content of the present inventions are to be defined only by the terms of the appended claims.

What is claimed is:

1. A foldable car seat which comprises:
an extendable back having raised curvilinear sides;
a seat having nesting raised curvilinear sides pivotally connected to said back;
a width of said seat and a width of said back being essentially the same;
a pair of rotatable armrests for said seat;
a pair of hubs at a bottom of said extendable back;
a pair of hubs at a rear of said seat;
a pair of hubs at a rear of said armrests;
a combination of said hub of said extendable back and said hub of said seat and said hub of said armrest each forming a side hub combination;
each side hub further comprising:
a means for retaining said armrest in either an up or a down position; and
a means for retaining said extendable back and said seat in either an L-shaped or collapsed position; and
said armrests unidirectionally attached to said hub combination.

2. The foldable car seat of claim 1 wherein said extendable back comprises:
a lower fixed back portion;
an upper adjustable back portion which telescopes in relation to said fixed back portion, said upper adjustable back portion moving from at least a first collapsed position to at least one extended position; and
a height adjustment means to secure said upper adjustable back portion in said at least two positions.

3. The foldable car seat of claim 2 wherein said height adjust means comprises:
a vertically extending member from said lower fixed back portion, said extending member having at least three laterally-extending spaced-apart teeth; and
a pair of opposed laterally-biased height locks in said adjustable back portion having at least one projection for mating insertion into a gap between said teeth.

4. The foldable car seat of claim 3 wherein said extendable back further comprises:
an upper headrest area with a pair of forward-extending wings, a portion of said headrest area having a pair of rear openings;
a lower back area with a pair of forward-extending curvilinear sides; and
said height locks extending through said pair of rear openings.

5. The foldable car seat of claim 1 wherein
said seat with raised curvilinear sides has a lowered area for securing an automobile lap belt therein to fit onto an occupant's bony pelvis.

6. The foldable car seat of claim 1 wherein each of said means for retaining said extendable back in either said L-shaped or collapsed position in said hub pair comprises:
a biased plunger slidable within a pair of rails in said seat hub, said seat hub having an aperture within said pair of rails;
an essentially perpendicular plunger extension at one end of said plunger for insertion into said aperture, said extension having at least one raised area;
said extendable back hub having at least a partial circular slot disposed therein for insertion of said plunger extension;
said at least partial circular slot in said extendable back hub having at least one raised detent for engagement with said at least one raised area on said plunger extension to retain said car seat in either said L-shaped or collapsed position.

7. The foldable car seat of claim 6 wherein each of said means for retaining said armrest in either said up or down position in said hub pair comprises:
an armrest plate having an interior and an exterior surface and an exterior peripheral edge and having at least one finger, said armrest plate retaining said plunger in said hub;
said plates having at least one raised projection on said interior surface for terminating circular movement of said armrest plate by contacting engagement of said at least one raised projection with at least one plunger rail in said seat hub;
said seat hub having at least two detents;
said at least one finger of said armrest plate engaging said at least one detent when said armrest is in either said up or down position.

8. The foldable car seat of claim 7 wherein
circular movement of said armrest plate is from about 60-120°.

9. The foldable car seat of claim 8 wherein said armrest plate comprises:
at least one finger; and
said seat hub has at least two detents;
said at least one finger mating with at least one of said at least two detents when said armrest is in said up position and mating with at least one other of said at least two detents when said armrest is in said down position.

10. The foldable car seat of claim 9 wherein said armrest plate further comprises:
said armrest plate and said armrest hub connect by a mating male projection means and a female receiving means.

11. The foldable car seat of claim 10 wherein
said male projection means is a T-shaped protrusion; and
said female receiving means is a C-shaped channel.

12. The car seat of claim 10 wherein said armrest plate further comprises:
at least one exteriorly-facing snap finger positioned interior of a peripheral edge of said armrest plate.

13. The car seat of claim 12 wherein said at least one snap finger engages a back wall of said armrest hub.

14. The foldable car seat of claim 1 which further comprises:
a pair of downwardly-extending legs extending from said back; and
a pair of rear legs on said seat.

15. The car seat of claim 1 wherein
each side hub combination pair shares a common pivot axis about at a height of said armrests.

16. The car seat of claim 1 wherein
at least a portion of a rear of said seat is used to permit said car seat to stand in an upright position when said car seat is in said collapsed position.

17. An extendable back for a car seat which comprises:
a lower fixed back portion, said fixed back portion having an essentially vertically extending member from said lower fixed back portion, said extending member having at least two laterally-extending spaced-apart teeth;
an upper adjustable back portion which telescopes in relation to said fixed back portion, said upper adjustable back portion moving from at least a first collapsed position to at least one extended position; and
a height adjustment means to secure said upper adjustable back portion in at least two positions, said height adjustment means comprising a pair of opposed laterally-biased height locks in said adjustable back portion having at least one projection for mating insertion with said teeth.

18. The foldable car seat of claim 17 wherein said extendable back further comprises:
an upper headrest area with a pair of forward-extending wings, a portion of said headrest area having a pair of rear openings;
a lower back area with a pair of forward-extending curvilinear sides; and
said height locks extending through said pair of rear openings.

19. A combination hub for a foldable car seat which comprises:
an armrest hub;
a seat back hub;
a seat hub;
a means for retaining said seat in either an L-shaped or collapsed position in said combination hub; and
a means for retaining said armrest in either an up or a down position in said combination hub;

20. The combination hub of claim 19 wherein said means for retaining said seat in either an L-shaped or collapsed position comprises:
a biased plunger slidable within a pair of rails in said seat hub, said seat hub having an aperture within said pair of rails;
an essentially perpendicular plunger extension at one end of said plunger for insertion into said aperture, said extension having at least one raised area;
said extendable back hub having at least a partial circular slot disposed therein for insertion of said plunger extension;
said at least partial circular slot in said extendable back hub having at least one raised detent for engagement with said at least one raised area on said plunger extension to retain said car seat in either said L-shaped or collapsed position.

21. The combination hub of claim 19 wherein said means for retaining said armrest in either said up or down position comprises:
an armrest plate having an interior and an exterior surface and an exterior peripheral edge and having at least one finger, said armrest plate retaining said plunger in said hub;
said plates having at least one raised projection on said interior surface for terminating circular movement of said armrest plate by contacting engagement of said at least one raised projection with at least one plunger rail in said seat hub;
said seat hub having at least two detents;
said at least one finger of said armrest plate engaging said at least one detent when said armrest is in either said up or down position.

22. The combination hub of claim 21 wherein
circular movement of said armrest plate is from about 60-120°.

23. The combination hub of claim 22 wherein said armrest plate comprises:
at least one finger;
said seat hub has at least two detents; and
said at least one finger mating with at least one of said at least two detents when said armrest is in said up position and mating with at least one other of said at least two detents when said armrest is in said down position.

24. The combination hub of claim 23 wherein
said armrest plate and said armrest hub connect by a mating male projection means and a female receiving means.

25. The foldable car seat of claim 24 wherein
said male projection means is a T-shaped protrusion; and
said female receiving means is a C-shaped channel.

26. The combination hub of claim 24 wherein said armrest plate further comprises
at least one exteriorly-facing snap finger positioned interior of a peripheral edge of said armrest plate.

27. The combination hub of claim 26 wherein
said at least one snap finger engages a back wall of said armrest hub.

28. A foldable car seat which comprises:
a back having raised curvilinear sides;
a seat having nesting raised curvilinear sides pivotally connected to said back;
a width of said seat and a width of said back being about the same;
a pair of rotatable armrests unidirectionally attached to said seat, said armrests separated by a distance across said car seat which is greater than said width across said back;
a connection means for said seat and said back;
a means for retaining said back and said seat in either an L-shaped or collapsed position;
a connection means for said unidirectionally attached armrests; and
a means for retaining said armrests in either an up or a down position.

29. The foldable car seat of claim 28 wherein
said connection means for said seat and said back and said connection means for said armrests are on a common fold axis located above a seating surface of said seat and forward of a back wall of said back.

30. The foldable car seat of claim 29 wherein said means for retaining said back in either said L-shaped or collapsed position comprises:
a biased plunger slidable within a pair of rails in a hub positioned at a rear of said seat, said seat hub having an aperture within said pair of rails;
an essentially perpendicular plunger extension at one end of said plunger for insertion into said aperture, said extension having at least one raised area;
said back having a hub having at least a partial circular slot disposed therein for insertion of said plunger extension;
said at least partial circular slot in said back hub having at least one raised detent for engagement with said at least one raised area on said plunger extension to retain said car seat in either said L-shaped or collapsed position.

31. The foldable car seat of claim 30 wherein said means for retaining said armrest in either said up or down position comprises:
an armrest plate having an interior and an exterior surface and an exterior peripheral edge and having at least one finger, said armrest plate retaining said plunger in said hub;
said plates having at least one raised projection on said interior surface for terminating circular movement of said armrest plate by contacting engagement of said at least one raised projection with at least one plunger rail in said seat hub;
said seat hub having at least one detent;
said at least one finger of said armrest plate engaging said at least one detent when said armrest is in either said up or down position.

32. The foldable car seat of claim 31 wherein circular movement of said armrest plate is from about 90-120°.

33. The foldable car seat of claim 32 wherein said armrest plate comprises:
at least one finger;
said seat hub has at least two detents;
said at least one finger mating with at least one of said at least two detents when said armrest is in said up position and mating with at least one other of said at least two detents when said armrest is in said down position.

34. The foldable car seat of claim 33 wherein
said armrest plate and said armrest hub connect by a mating male projection means and a female receiving means.

35. The foldable car seat of claim 34 wherein
said male projection means is a T-shaped protrusion; and
said female receiving means is a C-shaped channel.

36. The car seat of claim 34 wherein said armrest plate further comprises
at least one exteriorly-facing snap finger positioned interior of a peripheral edge of said armrest plate.

37. The car seat of claim 36 wherein
said at least one snap finger engages a back wall of said armrest hub.

38. A method for reducing a cube size of a car seat for shipping purposes, said car seat having approximately equal widths between a pair of raised curvilinear sides of a seating surface of said car seat and between a pair of raised curvilinear sides of a back of said car seat, said car seat having a pair of rotatable armrests separated by a distance which is greater than a width between said curvilinear sides of said back, said cube size being a combination of packaging carton length times width times height of said packaging carton for said car seat, said car seat assembly minimizing installation error after shipping, comprising the steps of:
folding said car seat along a fold axis, said axis located above said seating surface of said seat and forward of a back wall of said back prior to insertion of said car seat into said packaging carton;
inserting said pair of armrests into said packaging carton; and
unidirectionally installing said armrests after removal of said folded car seat and said inserted armrests from said packaging carton onto said car seat with a connection means providing installer feedback.

39. The method of claim 38 wherein said step of unidirectionally installing comprises:
matingly engaging a male projection means and a female receiving means.

40. The foldable car seat of claim 39 wherein
said male projection means is a T-shaped protrusion; and
said female receiving means is a C-shaped channel.

41. The method of claim 40 wherein said armrest plate further comprises
at least one exteriorly-facing snap finger positioned interior of a peripheral edge of said armrest plate.

42. The method of claim 41 wherein
said at least one snap finger engages a back wall of armrest hub providing sensory feedback to said installer.

43. The method of claim 42 wherein
said sensory feedback is selected from the group consisting of visual, audio and tactile.

44. A car seat with raised external sides which comprises:
a seat;
a back;
a pair of independently rotatable armrest mounting plates on said external sides sharing a common axis above said seat and in front of said back; and
a pair of armrests fixedly attachable to said armrest mounting plates by a mounting means.

45. The car seat of claim 44 wherein said mounting means comprises:
a mating male projection means and a female receiving means.

46. The car seat of claim 45 wherein
said male projection means is a T-shaped protrusion; and
said female receiving means is a C-shaped channel.

47. The car seat of claim 46 which further comprises:
a snap means engageable with a cooperating snap means on said armrest.

48. The car seat of claim 47 wherein
said seat and said back fold on said common axis.
